(19) United States
(12) Patent Application Publication
(10) Pub. No.: US 2019/0135197 A1
(43) Pub. Date: May 9, 2019

(54) IMAGE GENERATION DEVICE, IMAGE GENERATION METHOD, RECORDING MEDIUM, AND IMAGE DISPLAY SYSTEM

(71) Applicant: Panasonic Intellectual Property Management Co., Ltd., Osaka (JP)

(72) Inventor: MASANOBU KANAYA, Kanagawa (JP)

(21) Appl. No.: 16/237,338

(22) Filed: Dec. 31, 2018

Related U.S. Application Data
(63) Continuation of application No. PCT/JP2017/027423, filed on Jul. 28, 2017.

(30) Foreign Application Priority Data
Sep. 1, 2016 (JP) 2016-171093

(51) Int. Cl. B60R 11/04; B60R 11/02

(52) U.S. Cl. CPC B60R 11/04; B60R 11/0229; B60R 2300/8066; B60R 2300/50; B60R 2300/60; B60R 2300/30

(57) ABSTRACT

An image generation device is to be coupled to an imaging device and a display device, and includes a reflection analyzer and an image processor. The reflection analyzer analyzes a reflection degree of external light to a region showing a body of an own vehicle in a captured image which is output from the imaging device, and generates reflection data related to the reflection degree of the external light. The image processor processes the region showing the body of the own vehicle in the captured image based on the reflection data, generates a display image having a decreased reflection degree of the external light, and outputs the display image to the display device.

### CROSS-REFERENCE TO RELATED APPLICATIONS

This application is a continuation of the PCT International Application No. PCT/JP2017/027423 filed on Jul. 28, 2017, which claims the benefit of foreign priority of Japanese patent application No. 2016-171093 filed on Sep. 1, 2016, the contents all of which are incorporated herein by reference.

### BACKGROUND

### 1. Technical Field

The present disclosure relates to an image generation device, an image generation method, a recording medium, and an image display system.

### 2. Description of the Related Art

Recently, thanks to the advance and cost reduction in camera technology, various systems for supporting vehicle-drivers using an on-vehicle camera have been developed. As one of image display devices using on-vehicle cameras, a vision system has been developed. In this vision system, the situation of the region outside of the vehicle is imaged by an on-vehicle camera and is displayed on a display device as an image. Conventionally, such a situation is shown by an optical mirror. The vision system includes the on-vehicle camera and the display device.

Generally, in the vision system, at least a part of the body of the own vehicle is shown in an imaging region of a camera, and the driver can easily check the situation of the rearward of the vehicle or those in lateral sides outside the vehicle (see. International Patent Publication No. 2009/040974).

### SUMMARY

The present disclosure provides an image generation device, an image generation method, a recording medium, and an image display system that generate a display image of high visibility even when external light is reflected on a car body.

An image generation device of an aspect of the present disclosure is to be connected to an imaging device and a display device, and includes a reflection analyzer and an image processor. The reflection analyzer analyzes the reflection degree of the external light to the region showing a body of an own vehicle in a captured image which is output from the imaging device. Then, the reflection analyzer generates reflection data related to the reflection degree of the external light. The image processor processes the region showing the body of the own vehicle in the captured image on the basis of the reflection data, generates a display image having a decreased reflection degree of the external light, and outputs the display image to the display device.

In an image generation method of an aspect of the present disclosure, a captured image showing at least a part of a body of an own vehicle is received. Then, the reflection degree of external light to a region showing the body of the own vehicle in the captured image is analyzed, and reflection data related to the reflection degree of the external light is generated. Furthermore, on the basis of the reflection data, the region showing the body of the own vehicle in the captured image is processed, and a display image having a decreased reflection degree of the external light is generated.

A recording medium of an aspect of the present disclosure is a non-transitory recording medium that stores a program to be executed by a computer in the image generation device. The image generation device of computer causes the display device to display a captured image output from an imaging device. This program causes the captured image showing at least a part of a body of an own vehicle to be input from the imaging device, and causes the reflection degree of the external light to the region showing the body of the own vehicle in the captured image to be analyzed. Next, the program causes reflection data related to the reflection degree of the external light to be generated. Furthermore, on the basis of the reflection data, the program causes the region showing the body of the own vehicle in the captured image to be processed, and causes a display image having a decreased reflection degree of the external light to be generated.

### BRIEF DESCRIPTION OF DRAWINGS

FIG. 1 is a diagram showing one example of an image showing a rearward and a lateral side displayed by a general vision system.

FIG. 2 is a block diagram showing the configuration of an image display system in accordance with a first exemplary embodiment of the present disclosure.

FIG. 3 is a diagram showing one example of the installation state of the image display system in accordance with exemplary embodiments of the present disclosure.

FIG. 4 is a flowchart showing one example of the operation of an image generation device in accordance with the first exemplary embodiment.

FIG. 5 is a diagram schematically showing one example of a display image generated by the image generation device in accordance with the first exemplary embodiment.

FIG. 6 is a diagram schematically showing another example of the display image generated by the image generation device in accordance with the first exemplary embodiment.

FIG. 7 is a block diagram showing the configuration of an image display system in accordance with a second exemplary embodiment of the present disclosure.

FIG. 8 is a flowchart showing one example of the operation of an image generation device in accordance with the second exemplary embodiment.

FIG. 9 is a diagram schematically showing one example of a display image generated by the image generation device in accordance with the second exemplary embodiment.

FIG. 10 is a diagram schematically showing another example of a display image generated by the image generation device in accordance with the second exemplary embodiment.

FIG. 11 is a diagram showing one example of a hardware configuration of a computer.

### DETAILED DESCRIPTION OF PREFERRED EMBODIMENTS

In a general vision system, when a part of the body of the own vehicle is shown in the image displayed by a display device, a surrounding landscape reflected on the body and/or external light such as a lamp of another vehicle are indicated in a region displaying the body. Due to the external light indicated in the image, the driver sometimes hard to see the image, especially during high-speed driving of the own vehicle.

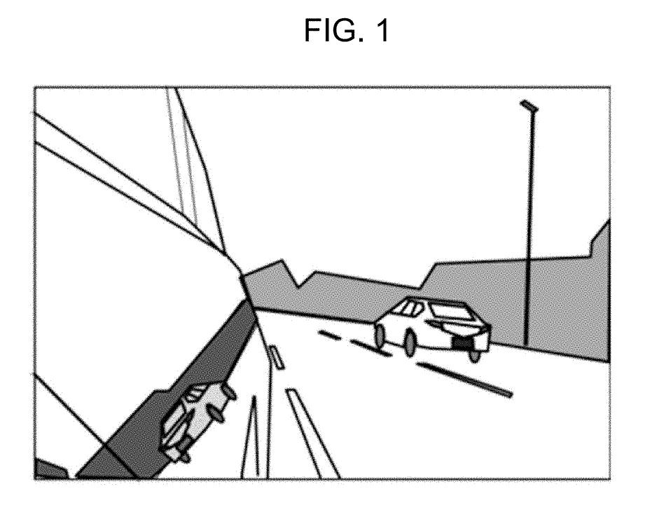

FIG. 1 is an example of an image showing a rearward and a lateral side displayed by a general vision system. As shown in FIG. 1, the imaging region of a side camera for imaging the rearward and the lateral side of the own vehicle includes not only the visual field of a right (or left) and the rearward of the own vehicle, but also a part of the body of the own vehicle. As discussed above, similarly to the case of using an optical side mirror, this condition allows the occupant of the own vehicle to easily recognize the lateral positional relation with respect to the rearward vehicle.

As shown in the image of FIG. 1, on the region showing the body of the own vehicle, a surrounding landscape or external light such as a lamp of another vehicle is reflected and relocated. Here, the surrounding landscape includes an oncoming car, or a scene such as a tree or building which looks like moving during the travel. Such an image sometimes disturbs the sight of the occupant. Furthermore, as the speed of the own vehicle becomes high, the image disturbs the sight of the occupant more. In a general vision system, an image having reflection is displayed as it is, so that the visibility is low and the occupant is likely to feel the eyestrain. Hereinafter, while addressing these problems, a configuration for generating a display image having a high visibility is described.

### First Exemplary Embodiment

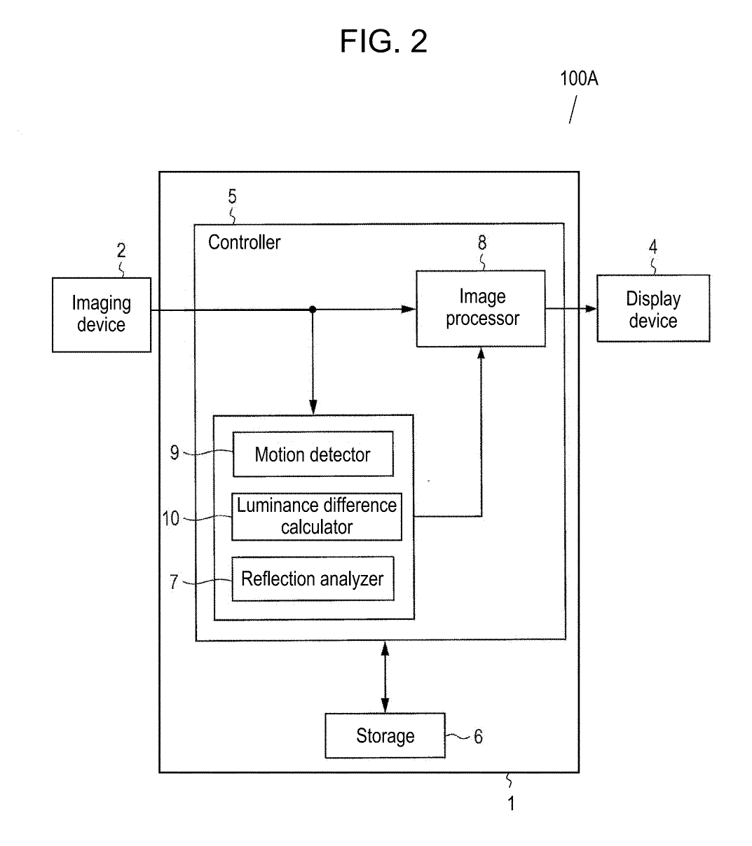

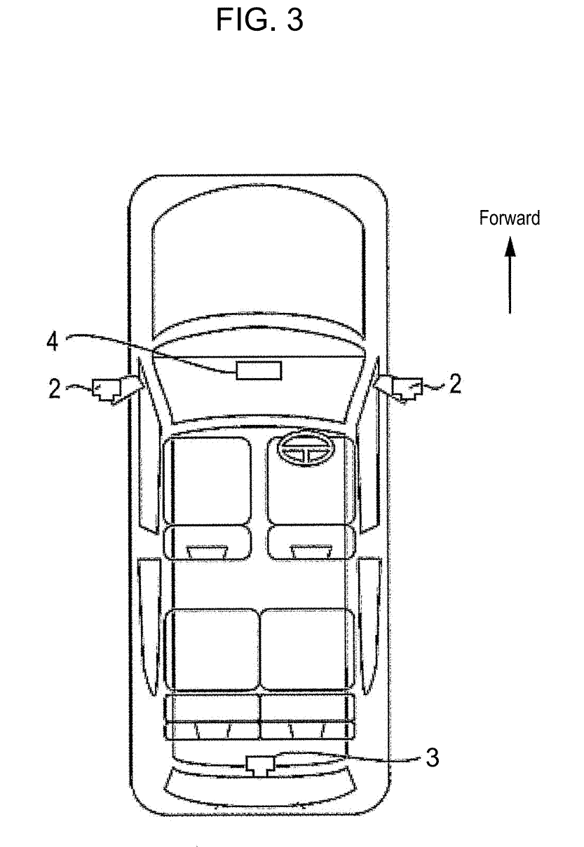

FIG. 2 is a block diagram showing the configuration of image display system 100A including image generation device 1 in accordance with a first exemplary embodiment of the present disclosure. FIG. 3 is a diagram showing one example of the installation state of image display system 100A. Image generation device 1 is connected to imaging device 2 and display device 4, and includes controller 5 and storage 6. Image display system 100A is a vision system that is mounted to the vehicle instead of an optical mirror.

Imaging device 2 outputs a first captured image acquired by imaging. The imaging region of the first captured image shows at least a part of the body of the own vehicle. In one example, imaging device 2 is a side camera for imaging a rear and lateral visual field of the own vehicle, and is fixed to the own vehicle.

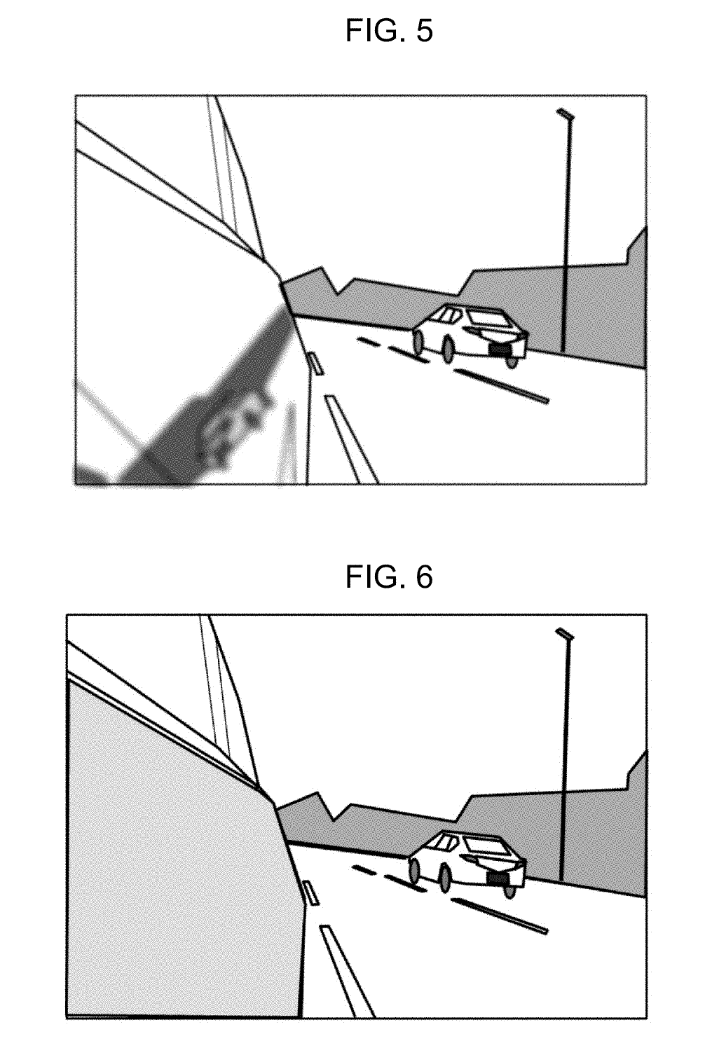

Display device 4 displays the image captured by imaging device 2, to an occupant (for example, driver). In one example, display device 4 is a liquid crystal display disposed in a dashboard. The detail of the display image is described later with reference to FIG. 5 and FIG. 6.

Controller 5 includes a central processing unit (CPU), a read only memory (ROM), and a random access memory (RAM). The CPU executes the following operations, for example:

reading a program corresponding to the processing contents from the ROM;

developing the program to the RAM; and

centrally controlling the operation of each block of image generation device 1 together with the developed program. Controller 5 functions as motion detector 9, luminance difference calculator 10, reflection analyzer 7, and image processor 8.

Storage 6 stores the shape of the part of the body of the own vehicle included in the imaging region of imaging device 2. In one example, storage 6 is a nonvolatile memory.

Motion detector 9 calculates a motion vector of an object reflected on the region showing the body of the own vehicle in the captured image input from imaging device 2. On the basis of the shape of the region showing the body of the own vehicle read from storage 6, motion detector 9 may calculate the motion vector of the object reflected on the region showing the body of the own vehicle. Specifically, the motion vector may be calculated by comparing two captured images taken at different times by imaging device 2, for example. In this calculation, the two captured images may be consecutive frame images. Alternatively, the two captured images may be nonconsecutive frame images extracted every a predetermined number of frames. In calculating the motion vector, the motion vector of a part of the object reflected on the region showing the body of the own vehicle may be calculated. Alternatively, motion detector 9 may calculate a motion vector in the whole region showing the body of the own vehicle in the captured image. In one example, the region showing the body of the own vehicle indicates the painted region other than the window part in the own vehicle.

Luminance difference calculator 10 acquires a maximum value and a minimum value of the luminance in the region showing the body of the own vehicle in the captured image input from imaging device 2, and calculates the difference thereof as the luminance difference. Luminance difference calculator 10 may calculate the luminance difference on the basis of the shape of the part of the body of the own vehicle read from storage 6. Alternatively, luminance difference calculator 10 may calculate the luminance difference in the whole of the region showing the body of the own vehicle in the captured image.

Reflection analyzer 7 analyzes a reflection degree of the external light to the region showing the body of the own vehicle in the captured image output from imaging device 2, and generates reflection data related to the reflection degree of the external light. As one example, reflection analyzer 7 generates the reflection data on the basis of the luminance difference calculated by luminance difference calculator 10. As another example, reflection analyzer 7 generates the reflection data on the basis of the motion vector amount calculated by the motion detector 9. The reflection data includes information indicating the reflection degree on the region showing the body, and includes a determining result whether or not a reflection to be reduced exists.

On the basis of the reflection data, image processor 8 generates a display image having a decreased reflection degree by processing the region showing the body of the own vehicle in the captured image. The generated display image is output to display device 4 and is displayed. The occupant of the own vehicle (for example, driver) can see an image having a decreased reflection degree via display device 4.

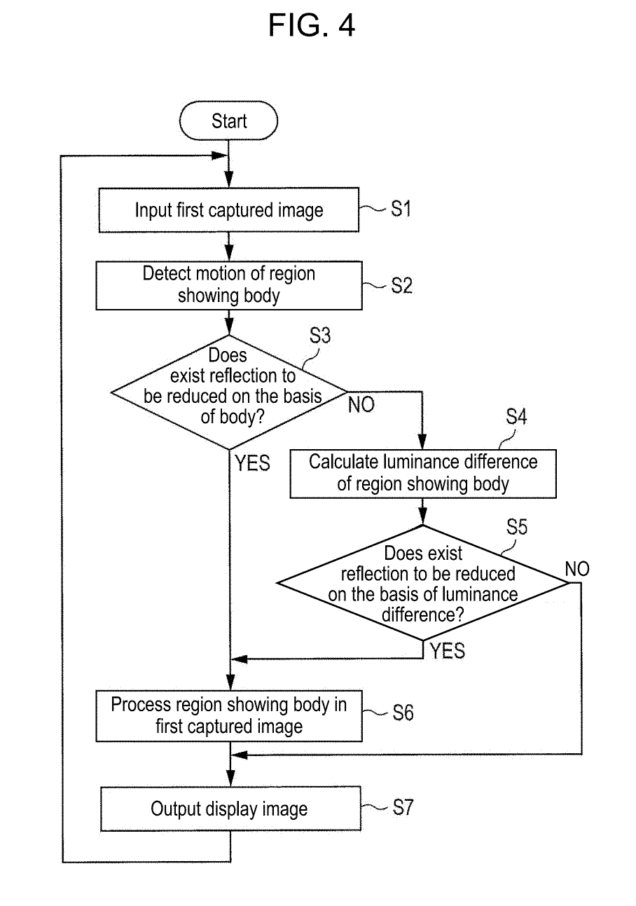

FIG. 4 is a flowchart showing one example of the operation of image generation device 1. This processing is achieved, for example, when the engine of the own vehicle starts up, and the CPU of image generation device 1 reads the program stored in the ROM and executes it.

In step S1, first, controller 5 receives a first captured image output from imaging device 2.

In step S2, controller 5 detects a motion of the object reflected on the region showing the body of the own vehicle in the captured image, which is the processing as motion detector 9. In one example, motion detector 9 calculates the motion vector amount of the object reflected on the region showing the body of the own vehicle in the captured image. The calculation of the motion vector amount is described later. Detecting the motion of the object reflected on the region showing the body allows the reflection degree on the region showing the body of the own vehicle to be acquired, and the motion can be used as an index in determining whether or not the reflection is to be reduced.

Here, imaging device 2 outputs a first image taken at a first time, and a second image taken at a second time which is before the first time. Motion detector 9 calculates the motion vector amount of the object reflected on the region showing the body of the own vehicle in the first image. Reflection analyzer 7 generates the reflection data on the basis of the motion vector amount determined by the above-mentioned method.

In step S3, controller 5 determines the presence or absence of the reflection to be reduced, on the basis of the motion of the object reflected on the region showing the detected body, which is the processing as reflection analyzer 7. The reflection to be reduced is a reflection that can reduce the visibility of the captured image, and becomes a processing object in the captured image. Specifically, the portion in which the calculated motion vector amount is a predetermined first value or more is detected as a motion region including the reflection to be reduced. In this case, reflection analyzer 7 generates the reflection data including the information of the motion region. The first value may be any value. For example, the occupant can set the first value using an operation panel (not shown).

When there is a region in which the motion vector amount is equal to or larger than the first value, namely a reflection to be reduced exists (step S3: YES), the processing goes to step S6. When there is not a reflection to be reduced (step S3: NO), the processing goes to the process of step S4.

In step S4, controller 5 calculates the luminance difference of the region showing the body of the own vehicle in the captured image, which is the processing as luminance difference calculator 10. Luminance difference calculator 10, for example, convers the captured image into an image in an HSV color space, acquires a maximum value and a minimum value of a V component, and calculates the difference between the maximum value and minimum value as a luminance difference. The HSV color space is a color space consisting of three components, hue, saturation and value. Here, the maximum value and minimum value of the V component correspond to the maximum value and minimum value of the luminance of the image reflected on the own vehicle, respectively.

In step S5, controller 5 determines the presence or absence of the reflection to be reduced on the basis of the calculated luminance difference, which is the processing as reflection analyzer 7. Specifically, when the luminance difference calculated by luminance difference calculator 10 is larger than the predetermined second value, it is determined that a reflection to be reduced exists. The second value may be any value. For example, the occupant can set the second value using an operation panel (not shown).

When the luminance difference is larger than the predetermined second value, namely a reflection to be reduced exists (step S5: YES), the processing goes to step S6. In one example, before going to step S6, luminance difference calculator 10 specifies, as a high-luminance region, a portion in which the luminance is a predetermined third value or more within the region showing the body of the own vehicle in the first captured image. In this case, reflection analyzer 7 generates the reflection data including information of a high-luminance region. The predetermined third value may be any value. For example, the occupant can set the third value using an operation panel (not shown). In contrast, when the luminance difference is not larger than the second value, namely a reflection to be reduced does not exist (step S5: NO), the processing goes to step S7.

In step S6, controller 5 processes the region showing the body of the own vehicle in the captured image, and generates a display image having a decreased reflection, which is the processing as image processor 8. In one example, the portion to be processed is the whole of the region showing the body of the own vehicle in the captured image. In another example, when the processing goes from step S3 to step S6, on the basis of the motion region included in the reflection data, only a portion in which a large motion is detected may be processed. In yet another example, when the processing goes from step S5 to step S6, only the high-luminance region included in the reflection data may be processed.

In one example, image processor 8 reduces the resolution of the region showing the body of the own vehicle in the captured image, by applying blurring processing or the like to the portion to be processed. In another example, image processor 8 overlays, on the portion to be processed, an image read from storage 6.

The overlaid image is a still image such as a picture of the own vehicle having no reflection, an illustration, or a graphic. In one example, storage 6 previously stores the image to be overlaid as a predetermined image, and image processor 8 reads the predetermined image from storage 6. When the image to be overlaid is uniformly colored, storage 6 may store the color instead of the image to be overlaid.

In step S7, controller 5 outputs, to display device 4, the display image generated by image processor 8. When a reflection to be reduced exists (step S3: YES or step S5: YES), the display image in which the reflection portion has been processed in step S6 is output in step S7. When a reflection to be reduced does not exist (step S3: NO and step S5: NO), the display image having been generated on the basis of the captured image is output.

FIG. 5 is one example of the display image generated by image generation device 1. The display image shown in FIG. 5 is a display image obtained when the whole region showing the body of the own vehicle in the captured image has been processed, and the resolution of the region showing the body is reduced. Compared with the captured image output by imaging device 2, the display image generated by image generation device 1 is an easy-to-see image having a low reflection, and the occupant seeing the display image hardly feels the fatigue of the eyes.

FIG. 6 is another example of a display image generated by image generation device 1 in accordance with the first exemplary embodiment. The display image shown in FIG. 6 is an image obtained when the whole region showing the body of the own vehicle in the captured image has been processed, and the region showing the body is filled with the uniform color.

As described above, image generation device 1 is to be connected to imaging device 2 and display device 4, and includes reflection analyzer 7 and image processor 8. Reflection analyzer 7 analyzes the reflection degree of the external light to the region showing the body of the own vehicle in the captured image output from imaging device 2. Then, reflection analyzer 7 generates reflection data related to the reflection degree of the external light. Image processor 8 processes the region showing the body of the own vehicle in the captured image, on the basis of the reflection data, generates a display image having a decreased reflection degree of the external light, and outputs the display image to the display device.

Compared with the captured image output by imaging device 2, the display image generated by image generation device 1 is an easy-to-see image having a decreased reflection, and the occupant seeing the display image hardly feels the fatigue of the eyes.

### Second Exemplary Embodiment

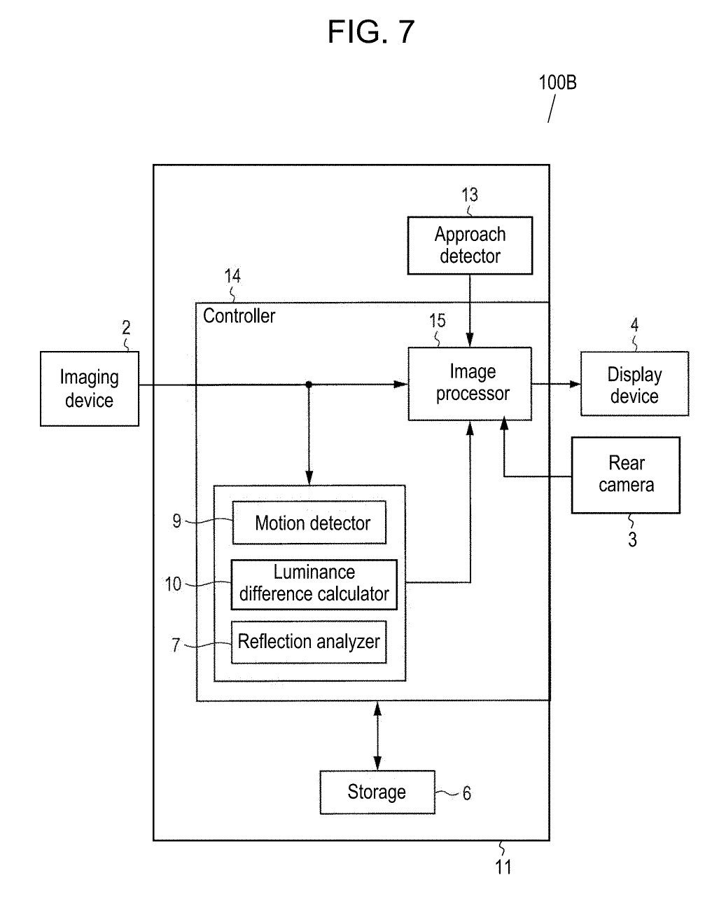

FIG. 7 is a block diagram showing a configuration of image display system 100B including image generation device 11 in accordance with a second exemplary embodiment of the present disclosure. Image generation device 11 is connected to imaging device 2 and display device 4, and includes controller 14, storage 6, and approach detector 13. Imaging device 2, display device 4, and storage 6 are similar to those described with respect to image generation device 1 in accordance with the first exemplary embodiment, so that the descriptions of those elements are omitted. Image display system 100B may include rear camera 3 described later.

Controller 14 includes a central processing unit (CPU), a read only memory (ROM), and a random access memory (RAM). The CPU reads, from the ROM for example, a program corresponding to the processing contents, develops it to the RAM, and centrally controls the operation of each block of image generation device 11 together with the developed program. Controller 14 functions as motion detector 9, luminance difference calculator 10, reflection analyzer 7, and image processor 15. Motion detector 9, luminance difference calculator 10, and reflection analyzer 7 are similar to those described in controller 5 in accordance with the first exemplary embodiment, so that the descriptions of those elements are omitted.

Approach detector 13 detects an approach of the other vehicle (rearward vehicle), and acquires approach data. Storage 6 stores an approach image indicating that a vehicle is approaching the own vehicle. On the basis of the approach of the other vehicle input from approach detector 13, image processor 15 overlays the approach image read from storage 6 on the region showing the body of the own vehicle in the captured image. In one example, approach detector 13 is a millimeter-wave radar for measuring the distance to the other vehicle behind the own vehicle, and acquires the approach data on the basis of the distance.

In one example, as shown in FIG. 7, image generation device 11 is further connected to rear camera 3 for imaging the rear portion of the own vehicle. Rear camera 3 is installed at the position of the rear portion shown in FIG. 3, and captures the image showing the other vehicle coming close to the own vehicle. Image processor 15 overlays the rear image input from rear camera 3 on the region showing the body of the own vehicle in the captured image. For example, on the basis of the approach data of the other vehicle input from approach detector 13, image processor 15 overlays the image showing the other vehicle approaching the own vehicle on the region showing the body of the own vehicle in the captured image. The image is read from rear camera 3. Rear camera 3 is installed at any position depending on the shape of the vehicle, such as an upper or rear portion of a backdoor glass of the own vehicle. Meanwhile, the output of rear camera 3 is input to image processor 15 in FIG. 7; however, rear camera 3 may output the captured rear image to approach detector 13. Alternatively, rear camera 3 may output and store the captured rear image to storage 6.

In one example, image processor 15 overlays at least a part of the rear image stored by the storage 6 on the region showing the body in the captured image. Here, in one example, at least a part of the rear image is a right half or a left half of the rear image.

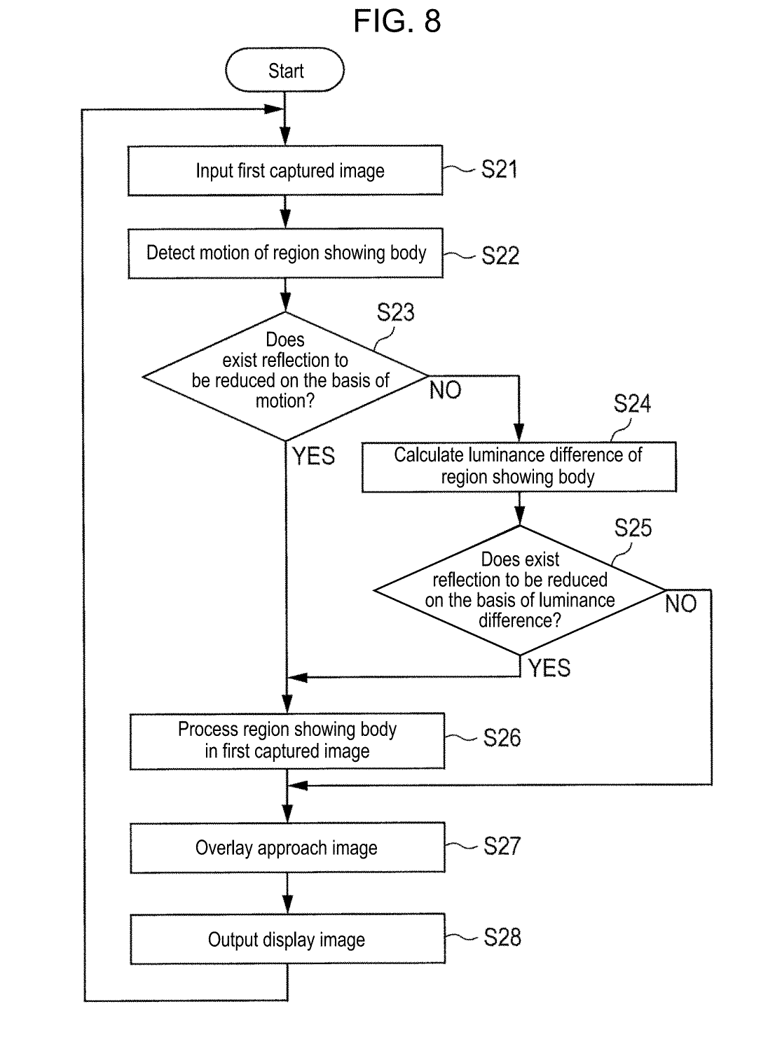

FIG. 8 is a flowchart showing one example of the operation of image generation device 11. Steps S21, S22, S23, S24, S25, S26 and S28 are similar to steps S1, S2, S3, S4, S5, S6 and S7 shown in FIG. 4, respectively, so that the descriptions of those steps are omitted.

Subsequently to step S25 or S26, in step S27, on the basis of the approach data of the other vehicle acquired by approach detector 13, controller 14 overlays the approach image read from storage 6 on the region showing the body of the own vehicle in the captured image.

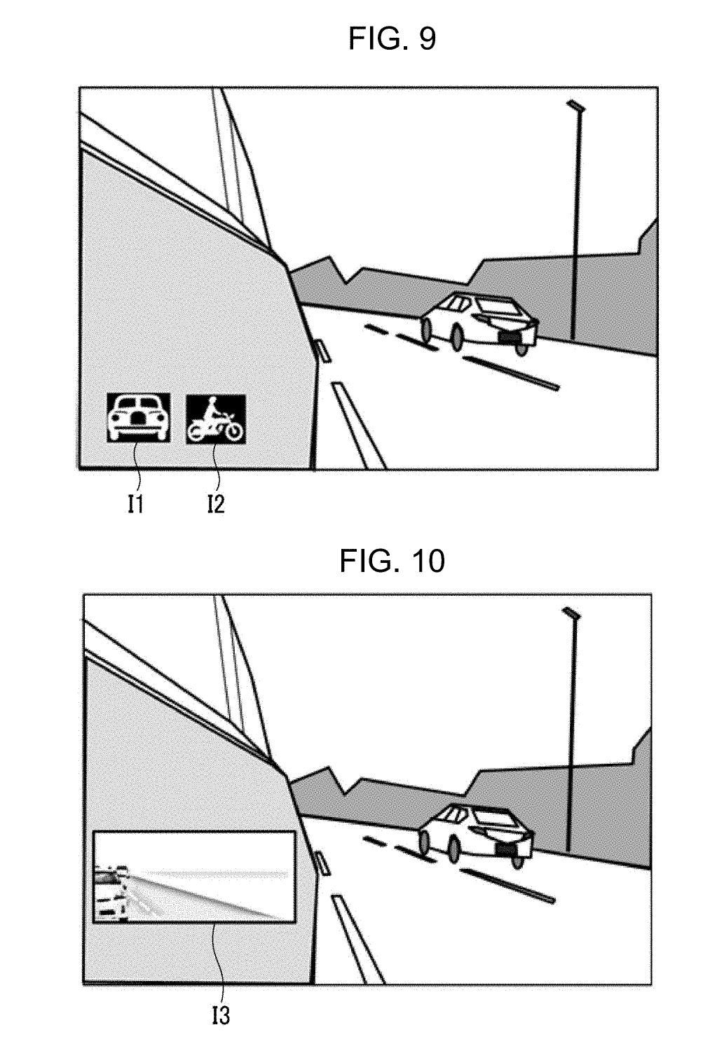

FIG. 9 is one example of a display image that is output to display device 4 from image generation device 11 in accordance with the second exemplary embodiment. Icons I1 and I2 are overlaid, as the approach data of the other vehicle, on the region showing the body in the display image.

FIG. 10 is another example of a display image that is displayed on display device 4 from image generation device 11. On the region showing the body in the display image, image I3 of a right half of the rear image captured by rear camera 3 is overlaid.

Thus, on the basis of the approach data of the other vehicle input from approach detector 13, image generation device 11 overlays the approach image read from storage 6 on the region showing the body of the own vehicle in the captured image.

Similarly to image generation device 1, even when the own vehicle travels at a high speed, the change in the display contents is small in the region showing the body of the display image generated by image generation device 11 because the reducing processing of the resolution or the overlay processing of a still image or the like is executed. Therefore, the occupant easily see at least a part of icons I1 and I2 or the rear image, compared with the case that simply approach information such as icons I1 and I2 or at least a part of the rear image are/is superimposed in the first captured image.

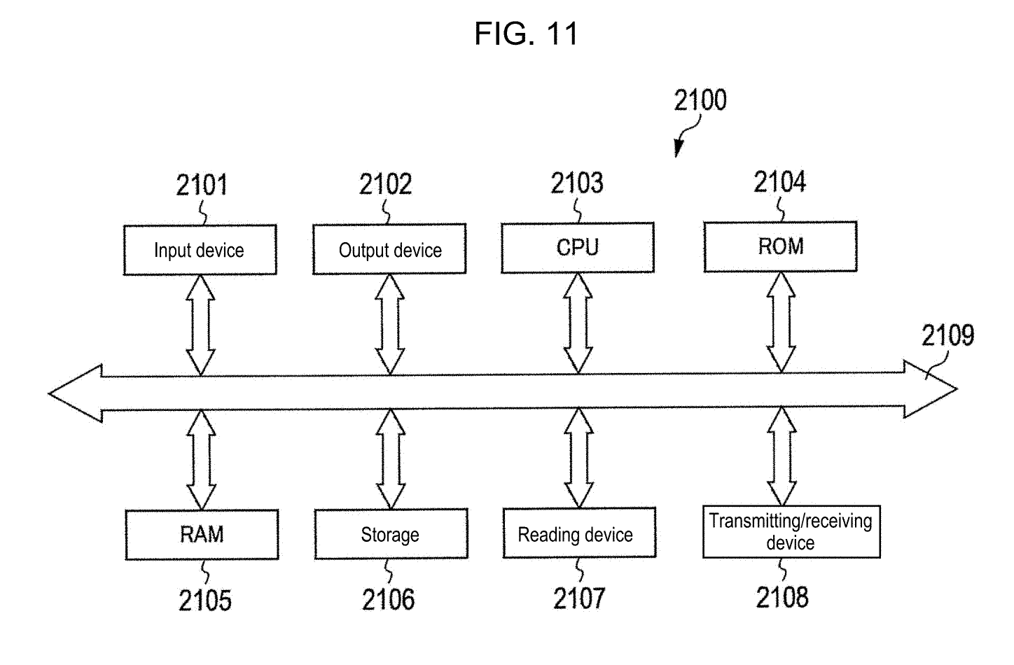

FIG. 11 is a diagram showing one example of a hardware configuration of a computer. The described functions of various elements in the exemplary embodiments and the modified examples are achieved by the programs executed by computer 2100.

As shown in FIG. 11, computer 2100 includes: input device 2101 such as an input button or a touch pad; output device 2102 such as a display or speaker; central processing unit (CPU) 2103; read only memory (ROM) 2104; and random access memory (RAM) 2105. Computer 2100 includes: storage 2106 such as a hard disk device or a solid state drive (SSD); reading device 2107 for reading information from recording medium such as a digital versatile disk read only memory (DVD-ROM) or a universal serial bus (USB); and transmitting/receiving device 2108 for performing communication via a network. The described portions are interconnected via bus 2109.

Reading device 2107 reads a program for achieving the function of each element, from a recording medium in which the program is recorded, and stores it in storage 2106. Alternatively, transmitting/receiving device 2108 performs a communication with a server device connected to the network, and stores, in storage 2106, the program for achieving the function of each element that is downloaded from the server device.

Then, CPU 2103 copies a program stored in storage 2106 to RAM 2105, and sequentially reads and executes commands included in the program from RAM 2105, and thereby achieving the command of each element. In executing the program, the information acquired by various processing described in the exemplary embodiments is stored in RAM 2105 or storage 2106, and are appropriately used.

### Other Exemplary Embodiments

In the first and second exemplary embodiments, each of image processors 8 and 15 reduces the resolution of the region showing the body of the own vehicle in the first captured image, or overlays another image or the like on an image showing the body. Instead of this, each of image processors 8 and 15 may reduce the luminance of the region showing the body.

In the first and second exemplary embodiments, each of controllers 5 and 14 determines whether to process the captured image on the basis of both of the luminance difference and the motion of the region showing the body of the own vehicle in the captured image. Instead of this, each of controllers 5 and 14 may determines whether to process the captured image, on the basis of one of the motion and the luminance difference. Whether to process the captured image may be determined, on the basis of the information other than the luminance difference or the motion of the region showing the body of the own vehicle in the captured image. For example, reflection analyzer 7 may determine the presence or absence of the direct sunlight during the day, on the basis of value of the illumination sensor mounted on the own vehicle, or may determine the presence or absence of the reflection to be reduced may be determined on the basis of the presence or absence of an oncoming vehicle or a following vehicle at night.

In the first and second exemplary embodiments, motion detector 9 detects the reflection motion by calculating the motion vector amount in the region showing the body of the own vehicle in the first captured image. Instead of this, each of controller 5 and 14 may input the speed information from the speed meter or the like of the own vehicle and may detect the reflection motion on the basis of the input speed information. Thus, motion detector 9 and luminance difference calculator 10 are not essential to controllers 5 and 14.

In the first and second exemplary embodiments, the presence or absence of the reflection on the region showing the body of the own vehicle in the captured image is examined, and determines whether to process the captured image is determined on the basis of the examination result. However, the determination of the presence or absence of the reflection is not always required. For example, after the region showing the body of the own vehicle in the captured image is determined, the following processing is performed:

the resolution of the region showing the body is reduced;

the picture, image, or diagram of the own vehicle is overlaid;

a rear image is overlaid; or

an approach image is overlaid.

An image generation device of the present disclosure is appropriate for being mounted to a vehicle instead of a mirror for reflecting the periphery of the vehicle, and for being used as a vision system.

What is claimed is:

1. An image generation device to be coupled to an imaging device and a display device, the image generation device comprising:
a reflection analyzer configured to analyze a reflection degree of external light to a region showing a body of an own vehicle in a captured image which is output from the imaging device, and to generate reflection data related to the reflection degree of the external light, and
an image processor configured to process the region showing the body of the own vehicle in the captured image based on the reflection data, to generate a display image having a decreased reflection degree of the external light, and to output the display image to the display device.

2. The image generation device according to claim 1,
wherein the image processor reduces a resolution of the region showing the body of the own vehicle in the captured image.

3. The image generation device according to claim 1, further comprising a storage storing an image,
wherein the image processor overlays the image read from the storage onto the region showing the body of the own vehicle in the captured image.

4. The image generation device according to claim 3, further comprising an approach detector configured to detect an approach of a rearward vehicle to the own vehicle and to output approach data of the rearward vehicle to the image processor,
wherein the storage stores an approach image, as the image, indicating that the rearward vehicle approaches the own vehicle, and
the image processor, based on the approach data, overlays the approach image read from the storage on the region showing the body of the own vehicle in the captured image.

5. The image generation device according to claim 1,
wherein the image generation device is further coupled to a rear camera operable to image a rearward view of the own vehicle to generate and output a rear image, and
the image processor overlays the rear image input from the rear camera onto the region showing the body of the own vehicle in the captured image.

6. The image generation device according to claim 5, further comprising an approach detector configured to detect an approach of a rearward vehicle to the own vehicle and to output approach data of the rearward vehicle to the image processor,
wherein the rear camera images an image showing the rearward vehicle, and
the image processor, based on the approach data, overlays the image indicating the rearward vehicle on the region showing the body of the own vehicle in the captured image.

7. The image generation device according to claim 1,
wherein the captured image is a first image taken at a first time, and the imaging device outputs a second image taken at a second time which is before the first time,
the image generation device further comprises a motion detector configure to calculate a motion vector amount of an object reflected on the region showing the body of the own vehicle in the first image, based on the first image and the second image, and
the reflection analyzer generates the reflection data based on the motion vector amount.

8. The image generation device according to claim 7,
wherein the image processor processes a portion in which the motion vector amount calculated by the motion detector is a predetermined first value or more in the captured image.

9. The image generation device according to claim 1, further comprising a luminance difference calculator configured to acquire a maximum value and a minimum value of a luminance in the region showing the body of the own vehicle in the captured image, and to calculate a difference, as a luminance difference, between the maximum value and the minimum value,
wherein the reflection analyzer generates the reflection data based on the luminance difference.

10. The image generation device according to claim 9,
wherein the image processor processes a portion in which the luminance difference calculated by the luminance difference calculator is larger than a predetermined second value in the captured image.

11. An image generation method comprising:
receiving a captured image showing at least a part of a body of an own vehicle;
analyzing a reflection degree of external light to a region showing the body of the own vehicle in the captured image, and generating reflection data related to the reflection degree of the external light; and
processing the region showing the body of the own vehicle in the captured image based on the reflection data, and generating a display image having a decreased reflection degree of the external light.

12. A non-transitory recording medium storing a program to be executed by a computer of an image generation device configured to display a captured image on a display device, the captured image showing at least a part of a body of an own vehicle and being output from an imaging device,
wherein the program causes the captured image to be input from the imaging device,
the program causes a reflection degree of external light to a region showing the body of the own vehicle in the captured image to be analyzed, and causes reflection data related to the reflection degree of the external light to be generated, and
the program causes the region showing the body of the own vehicle in the captured image is to be processed based on the reflection data, and causes a display image having a decreased reflection degree to be generated.

13. An image display system comprising:
an imaging device configured to output a captured image showing at least a part of a body of an own vehicle;
an image generation device coupled to an imaging device; and
a display device coupled to the image generation device,
wherein the image generation device includes:
a reflection analyzer configured to analyze a reflection degree of external light to a region showing a body of an own vehicle in a captured image which is output from the imaging device, and to generate reflection data related to the reflection degree of the external light, and
an image processor configured to process the region showing the body of the own vehicle in the captured image based on the reflection data, to generate a display image having a decreased reflection degree of the external light, and to output the display image to the display device.
